(19) United States
(12) Patent Application Publication
(10) Pub. No.: US 2017/0100994 A1
(43) Pub. Date: Apr. 13, 2017

(54) VEHICLE TAILGATE ASSEMBLY

(71) Applicant: Chris McAninch, Grimes, IA (US)

(72) Inventor: Chris McAninch, Grimes, IA (US)

(21) Appl. No.: 14/756,768

(22) Filed: Oct. 9, 2015

(51) Int. Cl. B60J 5/10

(52) U.S. Cl. CPC B60J 5/108

(57) ABSTRACT

A vehicle tailgate assembly for retaining a tailgate at a plurality of angles relative to the vehicle. A mounting plate is provided to the side a tailgate and provided with a stud to retain a tailgate retention cable to prevent the tailgate from fully opening relative to the vehicle. The stud may be moved to different securement holes within the mounting plate to allow the assembly to secure the cable and maintain the tailgate at a plurality of positions between locked and fully opened for the securement and transport of oversized loads.

### TECHNICAL FIELD

The disclosed embodiments relate generally to a vehicle tailgate assembly, and, in particular, to a vehicle tailgate assembly capable of retaining a tailgate in an acute orientation.

### BACKGROUND OF THE INVENTION

Vehicles, such as pickup trucks, are often provided with a tailgate opening a storage bed. The tailgate is pivotably connected to the vehicle to allow access to the bed. Typically, the tailgate may be opened until the tailgate becomes horizontal to allow for loading of the bed and thereafter pivoted to an upright locked position to maintain material within the bed. It is also known in the art to provide a tonneau cover over the vehicle bed to protect material being stored or transported in the bed. The tonneau cover may be constructed of a hard or soft material which may be secured to the vehicle by various types of fasteners. Hard tonneau covers may be opened by a hinge or folding mechanism. Soft covers may be opened by pulling them from the vehicle or rolling them up with a spring-actuated mechanism. Tonneau covers may also be locked to secure materials within the bed and prevent unauthorized access thereto.

One drawback associated with the prior art is the difficulty in securing oversize materials in the vehicle bed for transport. The transportation of materials larger than the bed often requires that either the tonneau cover be removed or retracted, or that the tailgate be in the horizontal position during transport. If the tonneau cover is retracted and the tailgate up, the oversize material may be angled in manner that exceed the desired height limits. Additionally, the oversize material may be damaged from the increased pressure of the tailgate on the material. Another drawback of such an orientation is that fast-moving air may bend or break the material if the vehicle is moving at a high speed. Another drawback associated with transporting oversize materials with the tailgate locked is that some tonneau covers are not designed to be transported in an unlocked position. Transporting such tonneau covers may lead to obstructed driver's view through the rear window. An additional drawback of transporting a tonneau cover in the partially open position may be that the lack of securement of the tonneau cover may lead to damage to the tonneau cover, the vehicle, and/or the oversize material being transported.

While material may be transported in the vehicle with the tonneau cover secured and the tailgate in the open and horizontal position, this orientation leads to other drawbacks. One drawback associated with such an orientation is that the oversize material may tend to slide out of the vehicle across the horizontal tailgate as the vehicle accelerates or moves along an upward incline. It would therefore be desirable to provide a vehicle tailgate assembly that allowed for oversize materials to be transported in the bed of a vehicle with the tonneau cover locked and the tailgate in an upwardly-angled orientation.

### SUMMARY OF THE DISCLOSED SUBJECT MATTER

The present invention includes an apparatus for retaining a tailgate of a vehicle. A tailgate is pivotably coupled to a vehicle having a first side and a second side. A flexible cable is coupled between the tailgate and the vehicle to secure the tailgate in an open horizontal position. A stud is secured to the tailgate between the pivot point of the tailgate relative to the vehicle and the point at which the cable is secured to the tailgate. The flexible cable is provided around the stud to secure the tailgate in a position between a locked position and an open horizontal positon.

### BRIEF DESCRIPTION OF THE DRAWINGS

The present invention will now be described, by way of example, with reference to the accompanying drawings in which:

FIG. 1 illustrates a side elevation in partial phantom of a vehicle provided with the tailgate assembly in accordance with one embodiment with the tailgate in the locked position;

FIG. 2 illustrates a top perspective view of the vehicle of FIG. 1 shown with tonneau cover retracted and the tailgate in the lowered horizontal position;

FIG. 3 illustrates the vehicle of FIG. 1 shown with the tailgate in the open horizontal position;

FIG. 4 illustrates a side elevation of the mounting plate and stud of FIG. 1;

FIG. 5 illustrates the vehicle of FIG. 1 shown with the tailgate retained at an angle less than forty-five degrees with an oversized object positioned in the vehicle bed;

FIG. 6 illustrates a side elevation of the vehicle of FIG. 1 shown with the stud located at an alternate position on the mounting plate and the cable releasably secured thereto to maintain the tailgate in an acute angle greater than forty-five degrees;

FIG. 7 illustrates the vehicle of FIG. 6 shown with an oversized object positioned within the bed of the vehicle.

### DETAILED DESCRIPTION OF THE DRAWINGS

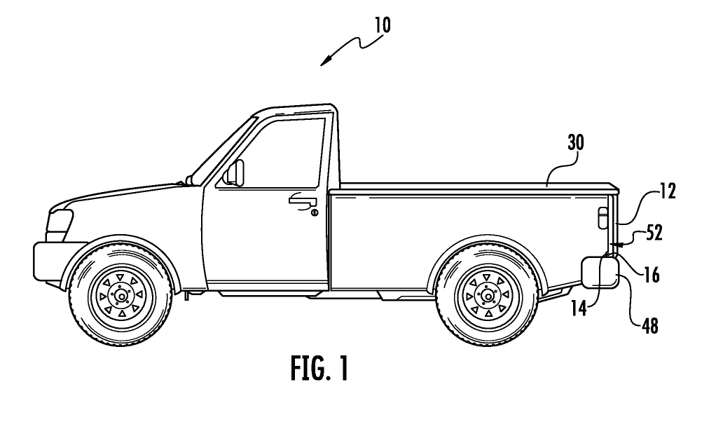

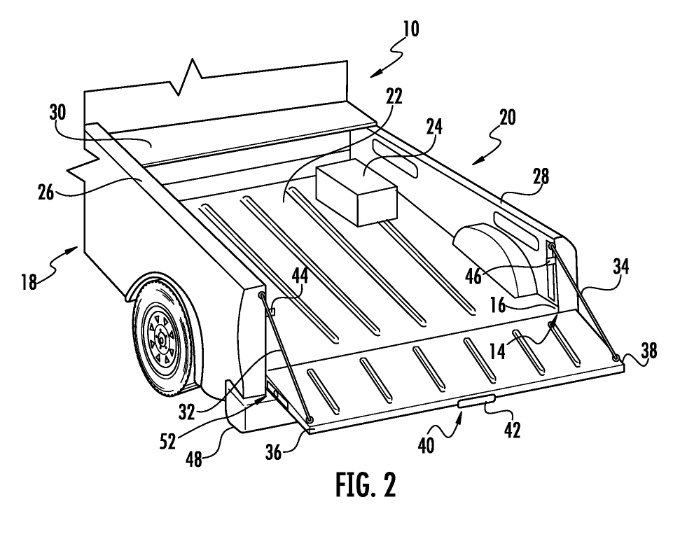

As shown in FIG. 1, a vehicle (10) such as a pickup truck is shown having a tailgate (12) pivotally coupled to the vehicle (10) at a pivot point (14) by a plurality of hinges (16). As shown in FIG. 2, the vehicle (10) is provided with a first side (18) and a second side (20). The vehicle (10) is also provided with a truck bed (22) for storing and transporting material (24). Provided on the sides (18) and (20) of the vehicle (10) are rails (26) and (28) along which run a retractable tonneau cover (30) which may be locked in extended position over the truck bed (22) to secure material (24) therein.

A pair of flexible cables (32) and (34), such as those known in the art, are coupled between the vehicle (10) and the tailgate (12). The first cable (32) is pivotally secured from the first side (36) of the tailgate (12) to the first side (18) of the vehicle (10). Similarly, the second cable (34) is pivotally coupled from the second side (38) to the second side (20) of the vehicle (10) in a manner such as that known in the art.

As shown in FIG. 2, provided within the tailgate (12) is a latching mechanism (40) operated by a handle (42) to engage a pair of islets (44) and (46) secured to the first side (18) and second side (20) of the vehicle (10), respectively, in a manner such as that known in the art.

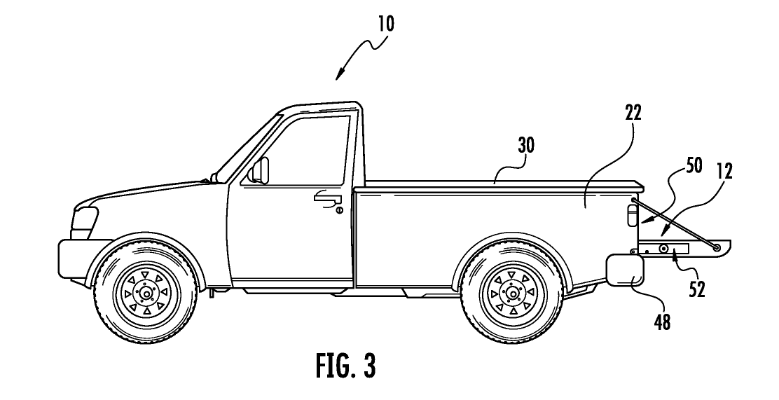

As shown in FIG. 3, when the tailgate (12) of the vehicle (10) is lowered, the tailgate (12) is generally horizontal relative to the truck bed (22) and held in place by the cables (32) and (34), FIGS. 2-3. The cables (32) and (34) prevent the tailgate (12) from hyperextending on the hinges (16) and coming into contact with the bumper (48) of the vehicle (10), thereby damaging the tailgate (12) and/or the bumper (48). While in the open position shown in FIG. 3, the tailgate (12) is preferably horizontal relative to the truck bed (22) and the angle of the rear (50) of the vehicle (10) relative to the tailgate (12) is preferably seventy-five to one hundred-five degrees, more preferably eighty-five to one hundred degrees, and most preferably about ninety degrees. Both of the locked tailgate positions shown FIG. 1 and the first unlocked tailgate position shown in FIG. 3 are known in the art.

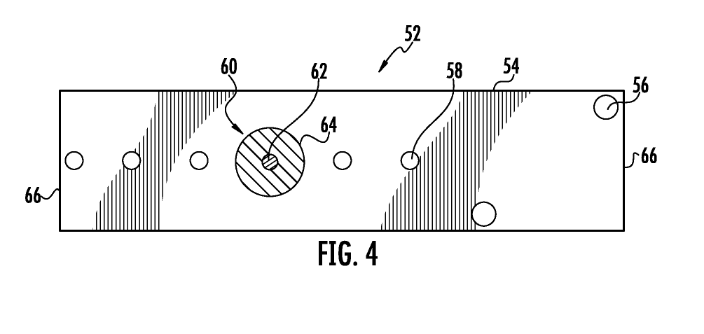

As shown in FIGS. 1-3, mounted to the first side (36) of the tailgate (12) is a cable retention assembly (52). The assembly (52) as shown in FIG. 4 has a mounting plate (54) provided with a plurality of unthreaded mounting holes (56) and a plurality of threaded stud securement holes (58). The mounting plate (54) may be constructed of any suitable material known in the art. In preferred embodiment, the mounting plate (54) is constructed of quarter-inch steel plate. While the mounting plate (54) is shown as being of a rectangular configuration, the configuration of the mounting plate (54) can be of any suitable dimensions. As shown in FIG. 4, the mounting holes (56) are preferably provided in the mounting plate (54) to match up with existing holes (not shown) provided in the standard tailgate (12) associated with the vehicle (10). Additional mounting holes (56) of any suitable dimensions and locations may be provided in the mounting plate (54). Additionally, additional holes (not shown) may be provided in the tailgate (12) if no existing holes exist, if additional holes are required, or if it is desired to mount the mounting plate (54) in a different location on the tailgate (12). The stud (60) is a threaded bolt (62) provided through a sheave (64) and treaded into one of the stud securement holes (58) in the mounting plate (54). As shown, the mounting plate (54) is provided with a plurality of stud securement holes (58) to change the location of the stud (60) to change the angle at which the cable retention assembly (52) maintains the tailgate (12) relative to the vehicle (10) when the cable (32) is provided around the stud (60). While in preferred embodiment, the stud (60) is a threaded bolt (62) provided through a sheave (64), the stud (60) may be constructed of suitable materials. As just one example, the stud 60 may be merely a bare threaded bolt (62) provided directly into the side (36) of the tailgate (12) in a manner that allows the cable (32) to slide along the body of the bolt (62) while the head of the bolt (62) maintains the cable (32) from slipping off the end of the bolt (62). As shown in FIG. 4, the stud (60) may be secured to one of the center stud securement holes (58) to retain the tailgate (12) at a substantially forty-five degree angle relative to the vehicle (10). If it is desired to retain the tailgate (12) at a more acute angle relative to the vehicle (10), the stud (60) may be secured in one of the stud securement holes (58) closer to the first end (66) of the mounting plate (54). Similarly, if it is desired to retain the tailgate (12) at an angle less acute relative to the vehicle (10), the stud (60) is removed and secured to one of the stud securement holes (58) closer to the second end (68) of the mounting plate (54). While the stud securement holes (58) are shown evenly spaced and along the same axis, the stud securement holes (58) may be of any suitable placement to obtain any desired angle of tailgate retention relative the vehicle (10).

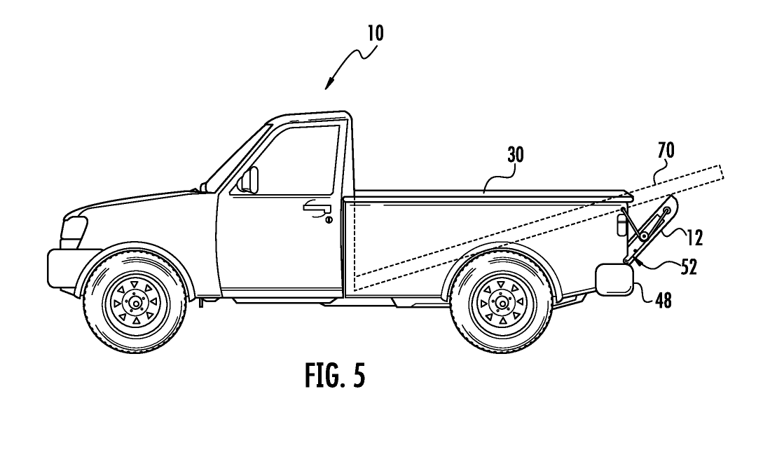

As shown in FIG. 5, if it is desired to transport a long thin piece of material (70) such as a long piece of wood, the stud (60) may be positioned within one of the stud securement holes (58) near the first end (66) of the mounting plate (54). The tailgate (12) then may be unlatched from the vehicle (10) using the handle (42) and the cable (32) manually provided around the stud (60) of the cable retention assembly (52). To secure the cable (32), the tailgate (12) is moved to a more acute position relative to the vehicle (10) than the desired maintenance position. Once the cable (32) is secured around the sheave (64), the tailgate (12) is lowered until it reaches the desired angle relative to the vehicle (10). Once this angle is achieved, the cable retention assembly (52) prevents the tailgate (12) from lowering further relative to the vehicle (10). As shown in FIG. 5, with the tonneau cover (30) closed, a long thin piece of material (70) may still be provided within the truck bed (22) with the tailgate (12) angled to reduce the distance the material (70) extends rearward from the vehicle (10) and to prevent the material (70) from sliding out of the truck bed (22) as the vehicle (10) accelerates or ascends an incline. When it is desired to remove the material (70) from the truck bed (22), the material (70) may be simply pulled rearward, or the tonneau cover (30) removed and the material (70) lifted upward. Once the material (70) has been removed, the tailgate (12) may be pivoted toward the vehicle (10) so that the cable (32) may be disconnected from the cable retention assembly (52), whereafter the tailgate (12) may be either opened to its first unlocked position or locked in an upright position in a manner such as that known in the art.

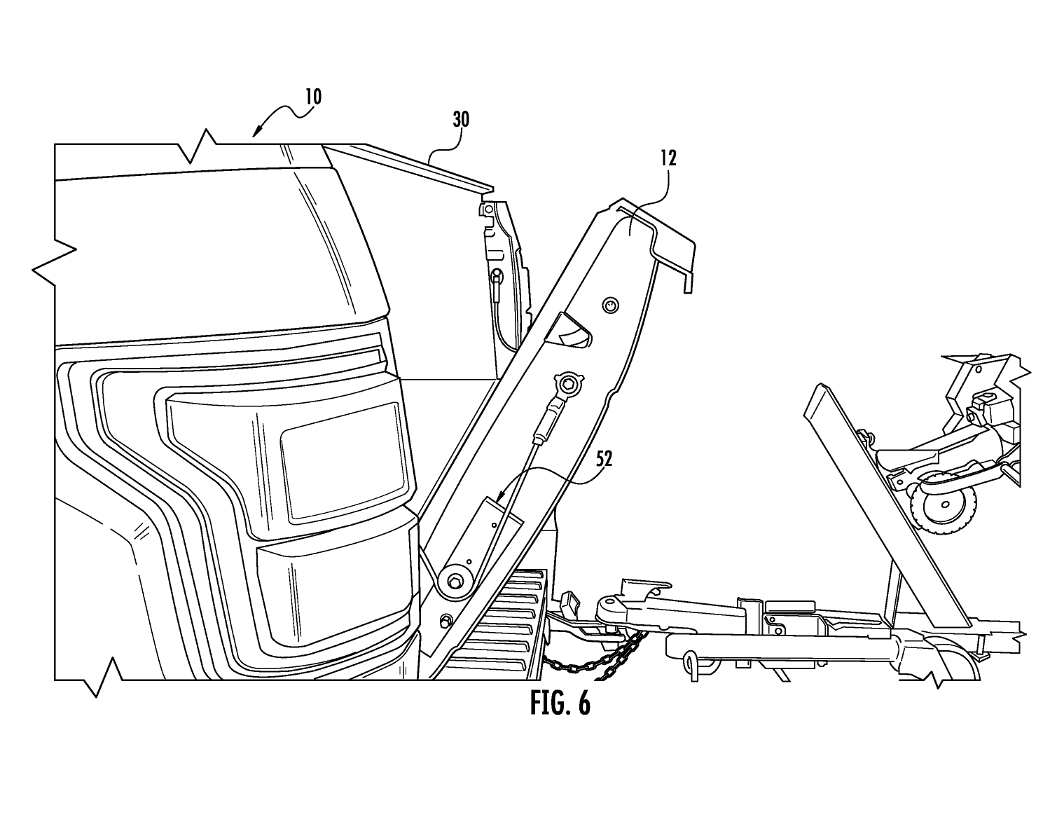

As shown in FIG. 6, only one cable retention assembly (52) is secured to one side (36) of the tailgate (12). The remaining cable (34) is preferably not secured to a cable retention assembly (52) as a single cable retention assembly (52) has been found suitable for most tasks. However, if it is desired to use the present invention in association with materials placing a heavy load on the partially-opened tailgate (12), a plurality of cable retention assemblies (52) provided to both sides (36) and (38) of the tailgate (12) may be used to retain both of the cables (32) and (34).

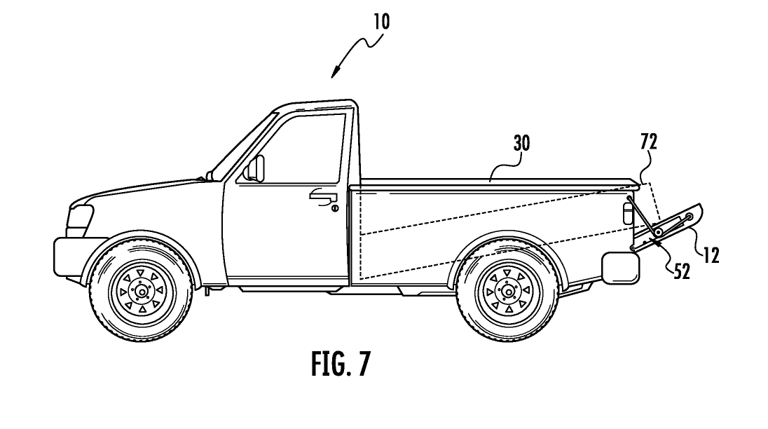

As shown in FIG. 7, if it is desired to transport a wider shorter material (72) such as a large pipe or the like, the stud (60) may be unscrewed from the mounting plate (54) and re-secured within a stud securement hole (58) located closer to the first end (66) of the mounting plate (54). Once the stud (60) has been relocated, the tailgate (12) may be unlocked and the cable (32) provided around the sheave (64) of the cable retention assembly (52). Thereafter, the material (72) may be positioned within the truck bed (22) to provide a slightly upward incline of the tailgate (12) relative to the vehicle (10) to allow the material (72) to fit between the tonneau cover (30) and the tailgate (12) while still using the tailgate (12) to retain the material (72) within the truck bed (22). When it is desired to remove the material (72) from the truck bed (22), the material (72) may be either directly removed or the tonneau cover (30) lifted so that the material (72) can be lifted from the truck bed (22). Once the material (72) has been removed, the tailgate (12) is lifted, the cable (32) removed from the cable retention assembly (52), and the tailgate (12) may thereafter secured in the locked position as explained above or opened to the first unlocked horizontal position as desired. While the stud securement holes (58) may be provided to secure the tailgate (12) in any desired position relative to the vehicle (10), in the preferred embodiment, the stud securement holes (58) are preferably provided to at least allow for maintenance of a second unlocked position such as that shown in FIG. 5, where the tailgate (12) is at an angle less than forty-five degrees relative to the vehicle (10) and a third unlocked position such as that shown in FIG. 7 with the tailgate (12) provided at an angle between forty-five and eighty degrees relative to the vehicle (10).

Although the invention has been described with respect to a preferred embodiment thereof, it is to be understood that it is not to be so limited, since changes and modifications can be made therein which are within the full, intended scope of this invention as defined by the appended claims. For example, the cable (32) may be replaced with a longer cable (not shown) to allow the tailgate (12) to be retained at a plurality of angles greater than ninety degrees relative to the vehicle (10) in addition to a plurality of angles less than ninety degrees relative to the vehicle (10).

What is claimed is:

1. A tailgate retaining apparatus comprising:
a) a vehicle having a first side and a second side;
b) a tailgate pivotably coupled to the vehicle at a pivot point, wherein the tailgate is pivotable between a locked position wherein the tailgate is locked to the first side of the vehicle, a first unlocked position angled generally between eighty and one hundred degrees from the locked position, and a second unlocked position angled generally greater than one and less than eighty degrees from the locked position;
c) a flexible cable having a first end and a second end, wherein the first end is coupled to the vehicle and wherein the second end is coupled to the tailgate at a securement point, wherein the flexible cable is of a sufficient length to maintain the tailgate in the second locked position; and
d) a stud secured to the tailgate between the pivot point and the securement point at a position sufficient to allow the flexible cable to maintain the tailgate in the first locked position when the flexible cable is releasably engaged with the stud.

2. The tailgate retaining apparatus of claim 1, wherein the stud is a sheave.

3. The tailgate retaining apparatus of claim 1, wherein the stud is secured to the tailgate by a mounting plate.

4. The tailgate retaining apparatus of claim 3, wherein the mounting plate defines a first hole sized to receive the stud and a second hole sized to receive the stud.

5. The tailgate retaining apparatus of claim 4, wherein the first hole is located at a first position wherein the stud is secured into the first hole and the flexible cable is releasably secured to the stud, the tailgate is maintained in the second locked position, and wherein the second hole is located at a second position wherein when the stud is secured into the second hole and the flexible cable is releasably secured to the stud, the tailgate is maintained in a third unlocked position between the first unlocked position and the second unlocked position.

6. The tailgate retaining apparatus of claim 3, wherein the mounting plate is releasably secured to the tailgate.

7. The tailgate retaining apparatus of claim 3, wherein the stud comprises a bolt securing a sheave to the mounting plate.

8. A tailgate retaining apparatus comprising:
a) a mounting plate secured to a tailgate of a vehicle wherein the tailgate is pivotable between an opened position and a closed position; and
b) a stud secured to the mounting plate, wherein the stud is configured to releasably retain a cable connected between the tailgate and the vehicle in a position that maintains the tailgate in a position between the opened position and the closed position.

9. The tailgate retaining apparatus of claim 8, wherein the stud is a sheave.

10. The tailgate retaining apparatus of claim 8, wherein the mounting plate defines a first hole sized to receive the stud and a second hole sized to receive the stud.

11. The tailgate retaining apparatus of claim 10, wherein the first hole is located at a first position wherein the stud is secured into the first hole and the flexible cable is releasably secured to the stud, the tailgate is maintained in the second locked position, and wherein the second hole is located at a second position wherein when the stud is secured into the second hole and the flexible cable is releasably secured to the stud, the tailgate is maintained in a third unlocked position between the first unlocked position and the second unlocked position.

12. The tailgate retaining apparatus of claim 11, wherein the stud comprises a bolt securing a sheave to the mounting plate.

13. The tailgate retaining apparatus of claim 8, wherein the stud comprises a bolt securing a sheave to the mounting plate.

14. A tailgate retaining apparatus comprising:
a) a mounting plate secured to a tailgate of a vehicle wherein the tailgate is pivotable between an opened position and a closed position;
b) a stud configured for releasably retaining a cable connected between the tailgate and the vehicle;
c) wherein the mounting plate is configured to receive the stud at a first location and a second location;
d) wherein the first location is located such that when the mounting plate received the stud at the first location, the stud retains the cable in a manner that maintains the tailgate in a first partially opened position between the opened position and the closed position;
e) wherein the second location is located such that when the mounting plate receives the stud at the second location, the stud retains the cable in a manner that maintains the tailgate in a second partially opened position between the opened position and the first partially opened position.

15. The tailgate retaining apparatus of claim 14, wherein the stud is a sheave.

16. The tailgate retaining apparatus of claim 14, wherein the mounting plate is releasably secured to the tailgate.

17. The tailgate retaining apparatus of claim 14, wherein the stud comprises a bolt securing a sheave to the mounting plate.
